(19) United States
(12) Patent Application Publication
(10) Pub. No.: US 2026/0288386 A1
(43) Pub. Date: Sep. 24, 2026

(54) PRINTING METHOD, IMAGE FORMING APPARATUS, AND IMAGE FORMING SYSTEM

(71) Applicant: SEIKO EPSON CORPORATION, Tokyo (JP)

(72) Inventor: Yasuhiro OSHIMA, Matsumoto (JP)

(21) Appl. No.: 19/571,639

(22) Filed: Mar. 19, 2026

(30) Foreign Application Priority Data
Mar. 21, 2025 (JP) 2025-046443

(51) Int. Cl. G06F 3/12; B41J 3/44; B41J 29/393

(52) U.S. Cl. CPC G06F 3/1222; G06F 3/1238; B41J 3/44; B41J 29/393

(57) ABSTRACT

A printing method executed by an image forming apparatus, the method including a scanning process, a storage process, a registration process, and a printing process. In the scanning process, an analog document is scanned to acquire scan data. In the storage process, authentication information of a user and a hash value of the scan data are stored in the scan data to generate electronic document data. In the registration process, a request for registering the electronic document data is issued to the blockchain management server. In the printing process, when a print execution instruction is acquired, transaction information is acquired from the blockchain management server based on the hash value in the electronic document data, it is determined whether or not the electronic document data is tampered with based on the information, and an image indicated by the scan data is printed based on a result of the determination.

The present application is based on, and claims priority from JP Application Serial Number 2025-046443, filed Mar. 21, 2025, the disclosure of which is hereby incorporated by reference herein in its entirety.

### BACKGROUND

### 1. Technical Field

The present disclosure relates to a printing method, an image forming apparatus, and an image forming system.

### 2. Related Art

JP-A-2022-76943 describes an image forming apparatus that embeds information for proving the existence of a paper document and tampering detection information in image data and prints the information on the paper document, and registers the information in a blockchain (BC) service in association with the paper document. The image forming apparatus described in JP-A-2022-76943 verifies authenticity and the presence or absence of tampering of the paper document by scanning a printed matter, decoding the embedded information, and inquiring the information registered in a block of the blockchain service.

Meanwhile, in the technique described in JP-A-2022-76943, data authenticity of an analog document such as a printed paper document cannot be ensured and printing such as print history management cannot be electronically managed.

Therefore, it is desired to develop a technology that can ensure the data authenticity of the printed analog document and electronically manage the printing.

### SUMMARY

According to an aspect of the present disclosure, there is provided a printing method executed by an image forming apparatus, the method including: executing a scanning process of scanning a first analog document, which is a portable document printed on a medium, to acquire first scan data; executing a storage process of storing authentication information authenticated by a user authentication process and a hash value of the first scan data in the first scan data to generate first electronic document data; executing a registration process of issuing a request for registering the first electronic document data as a first transaction to a blockchain management server; and executing a printing process of, when a print execution instruction for the first electronic document data is acquired, acquiring first transaction information indicating the first transaction from the blockchain management server, based on the hash value stored in the first electronic document data, determining whether or not the first electronic document data is tampered with based on the first transaction information, and printing an image indicated by the first scan data, based on a result of the determination.

According to another aspect of the present disclosure, there is provided an image forming apparatus including: a scan processing section that scans a first analog document, which is a portable document printed on a medium, to acquire first scan data; a storage processing section that stores authentication information authenticated by a user authentication process and a hash value of the first scan data in the first scan data to generate first electronic document data; a registration processing section that issues a request for registering the first electronic document data as a first transaction to a blockchain management server; and a print processing section, in which the print processing section is configured to, when a print execution instruction for the first electronic document data is acquired, acquire first transaction information indicating the first transaction from the blockchain management server, based on the hash value stored in the first electronic document data, determine whether or not the first electronic document data is tampered with based on the first transaction information, and print an image indicated by the first scan data, based on a result of the determination.

According to still another aspect of the present disclosure, there is provided an image forming system including: an image forming apparatus; and a blockchain management server coupled to the image forming apparatus, in which the image forming apparatus includes a scan processing section that scans a first analog document, which is a portable document printed on a medium, to acquire first scan data, a storage processing section that stores authentication information authenticated by a user authentication process and a hash value of the first scan data in the first scan data to generate first electronic document data, a registration processing section that issues a request for registering the first electronic document data as a first transaction to the blockchain management server, and a print processing section, the print processing section is configured to, when a print execution instruction for the first electronic document data is acquired, acquire first transaction information indicating the first transaction from the blockchain management server, based on the hash value stored in the first electronic document data, determine whether or not the first electronic document data is tampered with based on the first transaction information, and print an image indicated by the first scan data, based on a result of the determination, and the blockchain management server includes a server-side registration processing section that registers the first electronic document data as data of the first transaction in response to the request, and an information transmission section that returns the first transaction information to the image forming apparatus in response to a request for acquiring the first transaction information from the image forming apparatus.

### BRIEF DESCRIPTION OF THE DRAWINGS

FIG. 1 is a block diagram illustrating a configuration example of a printing system including an image forming apparatus according to an embodiment.

FIG. 2 is a schematic diagram illustrating a processing example in the printing system in FIG. 1.

FIG. 3 is a diagram illustrating an example of a data configuration of a transaction managed by a blockchain management server in the printing system in FIG. 1.

FIG. 4 is a flowchart describing an example of a printing method executed by the printing system in FIG. 1.

FIG. 5 is a diagram illustrating an example of a user interface image displayed on the image forming apparatus in the printing system in FIG. 1.

FIG. 6 is a flowchart describing an example of a process at a time of scanning in the printing method executed by the printing system in FIG. 1.

FIG. 7 is a flowchart describing an example of a process at a time of printing in the printing method executed by the printing system in FIG. 1.

FIG. 8 is a diagram illustrating an example of a printed matter printed by the image forming apparatus in the printing system in FIG. 1 and a printed matter after handwriting is performed.

FIG. 9 is a flowchart describing an example of a process at a time of second scanning in the printing method executed by the printing system in FIG. 1.

FIG. 10 is a block diagram illustrating another configuration example of the printing system including the image forming apparatus according to the embodiment.

FIG. 11 is a diagram illustrating an example of a user interface image displayed on the image forming apparatus in the printing system in FIG. 10.

FIG. 12 is a flowchart describing an example of a process at a time of scanning in the printing method executed by the printing system in FIG. 10.

FIG. 13 is a flowchart describing an example of a process at a time of printing in the printing method executed by the printing system in FIG. 10.

FIG. 14 is a diagram illustrating an example of a hardware configuration of the apparatus.

### DESCRIPTION OF EMBODIMENTS

Hereinafter, embodiments of the present disclosure will be described with reference to the drawings. Each drawing is only an example describing the embodiment of the present disclosure. In addition, not all of the components described in the embodiment of the present disclosure are essential components of the present disclosure.

### EMBODIMENT

### Configuration of System

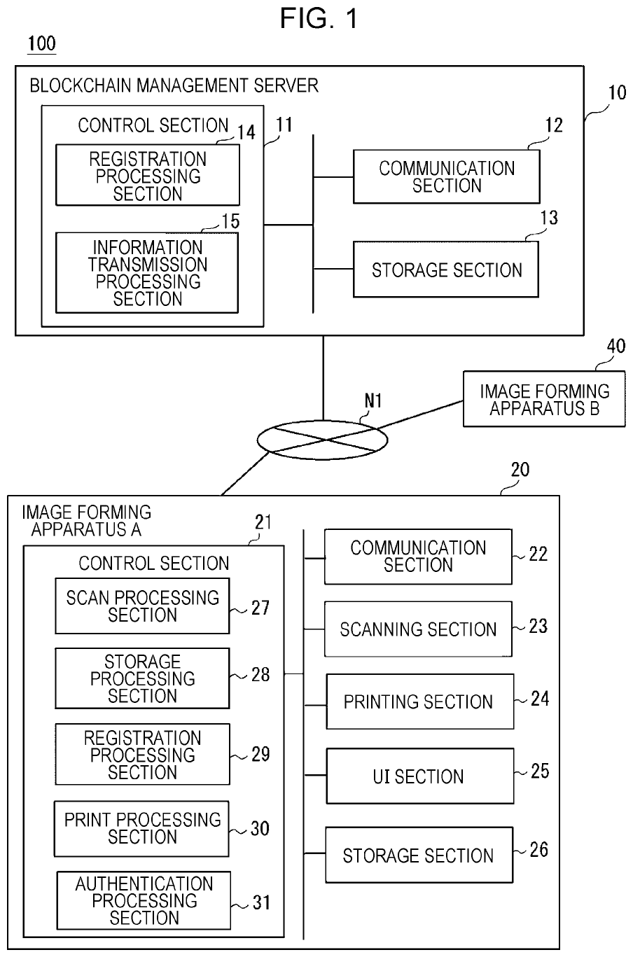

A configuration example of a printing system including an image forming apparatus according to the present embodiment will be described with reference to FIG. 1. FIG. 1 is a block diagram illustrating the configuration example of the printing system including the image forming apparatus according to the present embodiment.

As illustrated in FIG. 1, a printing system 100 according to the present embodiment includes a blockchain management server 10, an image forming apparatus A (20), and an image forming apparatus B (40), and the blockchain management server 10, the image forming apparatus A (20), and the image forming apparatus B (40) can be coupled to each other via a network N1.

The blockchain management server 10 (hereinafter, the server 10) is a server computer for managing a blockchain. The server 10 performs a process such as registration of a transaction.

The image forming apparatus A (20) is an example of an image forming apparatus on a side that has at least a scanning function and performs scanning. The image forming apparatus A (20) may be referred to as a scanner or an image processing apparatus. The image forming apparatus A (20) is an apparatus that registers electronic document data based on scan data as a transaction in the server 10, although details thereof will be described later.

The image forming apparatus B (40) is an example of an image forming apparatus on a side that has at least a printing function and executes printing of an image scanned by the image forming apparatus A (20) or the like to produce a printed matter. The image forming apparatus B (40) may be referred to as a printer. The image forming apparatus B (40) is an apparatus that receives electronic document data based on scan data from the image forming apparatus A (20), determines whether or not there is tampering based on transaction information indicating a transaction acquired from the server 10, and executes printing based on a determination result. Details of such a process will be described later.

Both the image forming apparatus A (20) and the image forming apparatus B (40) can have both the scanning function and the printing function, and function as a transmission side and a reception side. In the following, as such an example, an example in which a configuration example of the image forming apparatus B (40) is the same as a configuration example of the image forming apparatus A (20) will be described, and the description of the configuration example of the image forming apparatus B (40) will be omitted.

In addition, for convenience, the printing system 100 is described on the premise that the printing system 100 includes the two image forming apparatuses as described above, but the image forming apparatuses on the scanning side and the printing side may be the same image forming apparatus, and one or more image forming apparatuses may be included. In addition, each image forming apparatus includes a communication function for communication via the network N1, and may be a multifunction machine having other functions such as a facsimile communication function, in addition to a copying function.

Although not illustrated, the printing system 100 can include one or a plurality of terminal devices. The terminal device is an information processing apparatus having a communication function, such as a personal computer (PC), a smartphone, or a tablet terminal, and can be used by a user who desires to perform scanning or printing. The terminal device performs a process of transmitting a scan request or a print request, performs a setting operation for scanning or printing, and is coupled to the image forming apparatus A (20) and the image forming apparatus B (40) via the network N1 or another network. Meanwhile, for simplification of the description, the printing system 100 will be described only when the printing system 100 does not include such a terminal device and the setting operation or an execution operation for scanning or printing is performed from the image forming apparatus side.

### Configuration Example of Image Forming Apparatus

As illustrated in FIG. 1, the image forming apparatus A (20) can include a control section 21, a communication section 22, a scanning section 23, a printing section 24, a user interface (UI) section 25, and a storage section 26.

The control section 21 controls the entire image forming apparatus A (20). The control section 21 can be configured with, for example, an arithmetic processing device, a work memory, and a storage device that stores a control program, a parameter, and the like. The arithmetic processing device can be a central processing unit (CPU), a graphics processing unit (GPU), or the like. The arithmetic processing device can be referred to as a processor. The control section 21 can be configured as a system on a chip (SoC). As can be understood from these examples, the control section 21 can be configured to store the control program in an executable state. Meanwhile, the control section 21 can be configured to store a part of the control program as a circuit configuration such as a field-programmable gate array (FPGA), or may be configured as a dedicated circuit.

The control program described above can include a program for the arithmetic processing device to execute a process such as scanning or printing in cooperation with the communication section 22, the scanning section 23, the printing section 24, the UI section 25, and the storage section 26. In the following, an example in which at least a part of the control program is provided in the control section 21 will be described, but the control program may be stored in the storage section 26 provided separately from the control section 21.

The communication section 22 is a portion that communicates with an external apparatus such as the server 10 and the image forming apparatus B (40) via the network N1 wirelessly or by wire in accordance with a predetermined communication standard. The communication section 22 can be configured with one or a plurality of communication interfaces that can perform such communication. The network N1 is usually the Internet or the intranet including a local area network (LAN).

The scanning section 23 scans a document set on a document table or an automatic document feeder (ADF) provided in the image forming apparatus A (20) to generate scan data. Hereinafter, the original document will be referred to as an analog document since the original document is not a digital document. The analog document is a portable document printed on a medium such as paper or a sheet. In addition, the scanning can be performed optically.

The printing section 24 performs printing by forming an image indicated by print target data on a medium such as paper or a sheet. Various printing methods such as an ink jet printing method and a laser printing method can be applied, for example, regardless of the printing method in the printing section 24.

The UI section 25 is mainly configured with an operation section and a display section. The operation section is a portion that receives an operation by a user, and can be referred to as an operation receiving section. The operation section can be realized by, for example, any one or a plurality of a physical button, a touch panel mounted on the display section, and the like. In a configuration in which the operation section includes a touch panel, the operation section can also be referred to as an operation panel including the display section and the touch panel. The display section is a portion for displaying a UI image for operating the image forming apparatus A (20), and is configured with, for example, a liquid crystal display or a display device such as an organic electroluminescence display. The display section can include a display and a drive circuit for driving the display.

The storage section 26 is, for example, a hard disk drive, a solid state drive, or another storage device using a memory. The storage section 26 can store various types of data such as data related to various settings for scanning or printing and intermediate data at a time of scanning or printing.

Next, details of the control section 21 will be described. The control section 21 can include a scan processing section 27, a storage processing section 28, a registration processing section 29, a print processing section 30, and an authentication processing section 31.

The scan processing section 27 controls the scanning section 23 to scan an analog document set on the document table or the ADF to acquire scan data. For convenience, the analog document and the scan data are referred to as a first analog document and first scan data, respectively.

The storage processing section 28 stores authentication information authenticated by a user authentication process to be described later and a hash value of first scan data in the first scan data to generate electronic document data. Therefore, the storage processing section 28 includes a function of calculating the hash value of the first scan data. For convenience, the generated electronic document data is referred to as first electronic document data. The first electronic document data can be, for example, data in which the authentication information and the hash value described above are stored in at least one of the header and the footer.

The registration processing section 29 makes a request for registering the first electronic document data as a transaction with the server 10. For convenience, this transaction is referred to as a first transaction. In response to the request, the server 10 registers the first electronic document data as the first transaction.

When a print execution instruction for the first electronic document data is acquired from the UI section 25 or the like, the print processing section 30 acquires first transaction information indicating the first transaction from the server 10 based on the hash value stored in the first electronic document data. The print execution instruction for the first electronic document data is synonymous with a print execution instruction designating the first scan data.

The print execution instruction can be an instruction from the registrant side, that is, an instruction received by the UI section 25. In this case, the subsequent process in the print processing section 30 is a process on the image forming apparatus A (20) side. Alternatively, the print execution instruction may be a print execution instruction from the image forming apparatus B (40) that is a transmission destination of the first electronic document data. In this case, the subsequent process in the print processing section 30 is a process on the image forming apparatus B (40) side. Further, the print execution instruction may be a print execution instruction from a terminal device such as a mobile terminal or a PC. In this case, the terminal device transmits the first electronic document data to the image forming apparatus A (20), and the subsequent process in the print processing section 30 is a process in the image forming apparatus A (20). Alternatively, the terminal device transmits the first electronic document data to the image forming apparatus B (40), and the subsequent process in the print processing section 30 is a process in the image forming apparatus B (40).

The print processing section 30 determines whether or not the first electronic document data is tampered with based on the first transaction information. Here, it can be determined that there is tampering when the hash value stored in the first electronic document data is changed, based on the hash value indicated by the first transaction information.

Based on the result of the determination, the print processing section 30 prints the image indicated by the first scan data. As a simpler example, the print processing section 30 may not perform printing when the result of the determination indicates that there is tampering, and may execute printing of the image indicated by the first scan data when the result of the determination indicates that there is no tampering. When printing is not performed, it may be notified that there is tampering or a simple error. The notification can be one or both of a notification to the UI section 25 and a notification by printing an image including information indicating that there is tampering. The information indicating that there is tampering may be notified by printing the information in a superimposed manner on the image indicated by the first scan data.

The authentication processing section 31 executes the user authentication process described above. Information to be authenticated, such as a user ID and a password can be obtained by receiving the information from the UI section 25 or by reading user information in an IC card possessed by the user by providing a card reader in the UI section 25. Authentication information, which is information for authenticating the information to be authenticated, may be stored such that the authentication information is referable only by the number of users who perform the authentication. The authentication information can be stored in the storage section 26 or can be stored in an authentication server coupled to the image forming apparatus A (20) separately. Such a system for authentication can be constructed to perform authentication in cooperation with, for example, an enterprise management system.

The authentication processing section 31 can receive the information to be authenticated from the UI section 25, collate the received information with a plurality of pieces of stored authentication information, and obtain a user authentication process result of success in authentication when the received information matches any of the plurality of pieces of stored authentication information, and failure in authentication when the received information does not match any of the plurality of pieces of stored authentication information. The authentication information stored in the first electronic document data in the storage processing section 28 may be authentication information of the originally stored side, or may be information to be authenticated, which is successfully authenticated.

### Configuration Example of Server 10

The server 10 can be, for example, a management server of a blockchain node. Meanwhile, the printing system 100 may not include the management server of the blockchain node, and may include each information processing apparatus (hereinafter, a distributed processing apparatus) that performs distributed management of the blockchain. In this case, each distributed processing apparatus functions as the server 10 or a part of the server 10, which will be described below. Further, even when the printing system 100 includes the management server of the blockchain node, each distributed processing apparatus may function as the server 10 or a part of the server 10 to be described below.

As illustrated in FIG. 1, the server 10 can include a control section 11, a communication section 12, and a storage section 13. The control section 11 controls the entire server 10. The control section 11 can be configured with, for example, an arithmetic processing device, a work memory, and a storage device that stores a control program, a parameter, and the like. The arithmetic processing device is also referred to as a processor. The control section 11 can also be configured as an SoC. As can be understood from these examples, the control section 11 can be configured to store the control program in an executable state. Meanwhile, the control section 11 can be configured to store a part of the control program as a circuit configuration such as an FPGA, or may be configured as a dedicated circuit.

The control program can include a program for the arithmetic processing device to execute a process for the blockchain management in cooperation with the communication section 12 and the storage section 13. In the following, an example in which at least a part of the control program is provided in the control section 11 will be described, but the control program may be stored in the storage section 13 provided separately from the control section 11.

The communication section 12 is a portion that communicates with the image forming apparatus A (20), the image forming apparatus B (40), an external apparatus such as each information processing apparatus that performs distributed management of the blockchain, via the network N1 in accordance with a predetermined communication standard. The communication section 12 can be configured with one or a plurality of communication interfaces that can perform such communication.

The storage section 13 is, for example, a hard disk drive, a solid state drive, or another storage device using a memory. The storage section 13 can store various types of data such as data related to various settings for blockchain management including management of the blockchain node.

Next, details of the control section 11 will be described. The control section 11 can include a registration processing section 14, which is a server-side registration processing section, and an information transmission processing section 15.

The registration processing section 14 registers the first electronic document data as data of the first transaction in response to a request from the image forming apparatus A (20). Meanwhile, the registration processing section 14 can be substituted with the same function as the registration processing section 14 on each distributed processing apparatus side coupled to the server 10, without being provided in the server 10.

The information transmission processing section 15 receives a request for acquiring the first transaction information from the image forming apparatus A (20) via the communication section 12, and responds to the request via the communication section 12 to return the first transaction information to the image forming apparatus A (20).

### Processing Example of Printing System 100

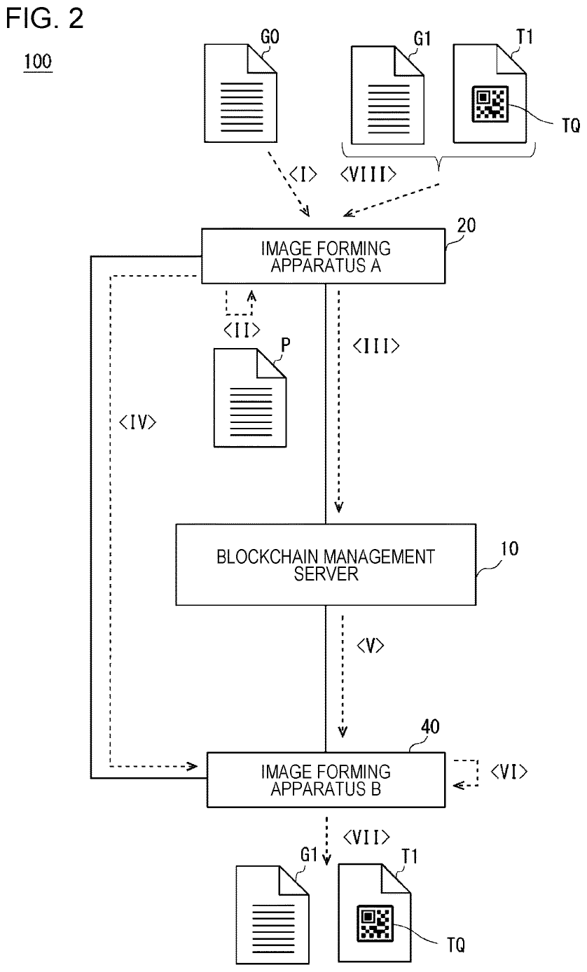

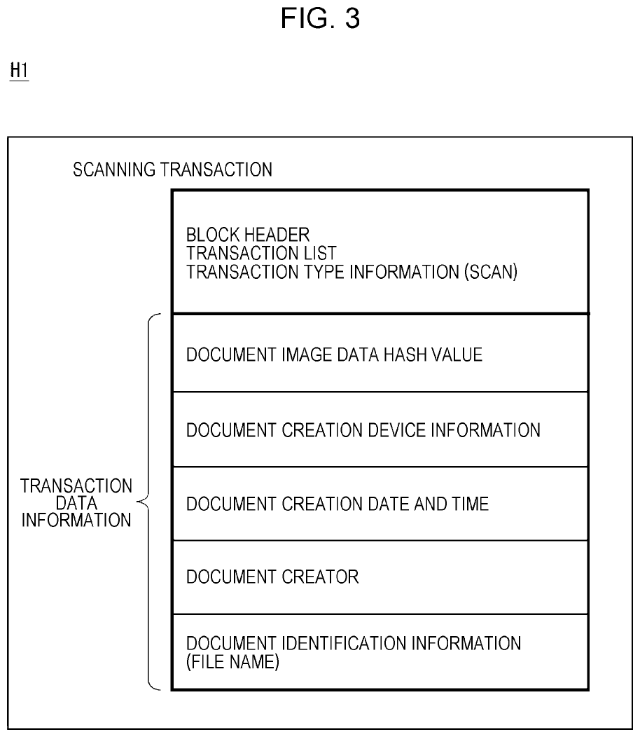

As a processing example of the printing system 100, a processing example when the image forming apparatus A (20) transmits the first electronic document data to the image forming apparatus B (40) will be described with reference to FIGS. 2 to 4. FIG. 2 is a schematic diagram illustrating a processing example in the printing system 100. FIG. 3 is a diagram illustrating an example of a data configuration of a transaction managed by the server 10 in the printing system 100.

As illustrated in FIG. 2, first, a first analog document G0 is set in the image forming apparatus A (20) (process I), and the image forming apparatus A (20) executes a scanning process and a storage process to generate first electronic document data P (process II). The electronic document data P can be, for example, Portable Document Format (PDF) data, but is not limited thereto. For example, even in JPEG data and PNG data, authentication information and a hash value can be added as custom information in EXIF metadata and a tEXt chunk, respectively. JPEG is an abbreviation for Joint Photographic Experts Group. PNG is an abbreviation for Portable Network Graphics. EXIF is an abbreviation for Exchangeable Image File Format.

Next, the image forming apparatus A (20) issues a request for registering the first electronic document data P as a first transaction to the server 10 (process III). The server 10 executes the registration based on the request. The server 10 registers a scanning transaction H1 illustrated in FIG. 3 in a block as, for example, the first transaction.

The scanning transaction H1 illustrated in FIG. 3 can include, in addition to information necessary as the transaction, a transaction list indicating a transaction to be referred to, and transaction type information, in a block header. The transaction type information in this example is information indicating scanning.

In addition, the scanning transaction H1 can include a hash value for the first electronic document data P and device information of the image forming apparatus A (20), which is a device which creates the first electronic document data P, as transaction data information indicating transaction data. Further, the scanning transaction H1 can include, as the transaction data information, information on a creation date and time, information on a document creator indicated by authentication information authenticated by the user authentication process, and document identification information such as a file name, for the first electronic document data P.

Further, the image forming apparatus A (20) transmits the first electronic document data P, which is data of a scan image as a transmission target, to the image forming apparatus B (40) by attaching the first electronic document data P to an e-mail or the like or by file transfer (process IV). An order of the process IV and the process III is not limited, but it is assumed that the process III and the process IV are executed before a process V to be described later.

Next, when receiving a print execution instruction for the received first electronic document data P, the image forming apparatus B (40) acquires the first transaction information indicating the first transaction from the server 10 based on the hash value in the first electronic document data P (process V). The image forming apparatus B (40) determines whether or not the first electronic document data P is tampered with based on the first transaction information (process VI).

Next, when a result of the determination indicates that there is no tampering, the image forming apparatus B (40) produces a printed matter G1 by printing the image indicated by the first scan data (process VII). In the process VII, the image forming apparatus B (40) may execute printing of a transaction identification sheet T1 before or after printing of the printed matter G1.

The transaction identification sheet T1 is a sheet used for identification indicating that the next scanning is scanning to be continuously managed by the server 10. The above sheet is not limited to paper, and may be another type of medium such as a film. The transaction identification sheet T1 is, for example, a sheet on which code information indicating a transaction ID of the first transaction is printed, as a QR code (registered trademark and the same is applied below) TQ.

The transaction ID is a unique ID for each transaction of the blockchain. Therefore, by printing the code information indicating the transaction ID of the first transaction in this manner and scanning the printed code information at a time of the next scan to inquire a storage destination of the code information, the fact that the scanning is for a second transaction can be specified. In addition, by such specification, the above next scanning can be scanning registered as the second transaction referring to the first transaction, and can be interpreted as scanning for continuing the transaction.

Examples of the storage destination of the code information will be described. The code information may be stored in the image forming apparatus B (40) for collation at a time of the next scanning. In that case, the code information may be stored such that the code information can be referred to by accessing from the image forming apparatus A (20), and the image forming apparatus A (20) may store a transmission destination of the first electronic document data P. Alternatively, the image forming apparatus B (40) may return to the image forming apparatus A (20) that is a transmission source of the first electronic document data P with the code information, and the image forming apparatus A (20) may manage the code information. Alternatively, the image forming apparatus B (40) may transmit the code information to the server 10, and the server 10 may manage the code information. In any case, the image forming apparatus A (20) and the image forming apparatus B (40) can access the code information.

Here, the scanning to be continuously managed can mean scanning to be continuously managed by ensuring authenticity of the first analog document G0, that is, scanning with which a blockchain transaction is to be continued. The ensuring of the authenticity here means to ensure the authenticity of the first analog document G0 that is an original of the printed matter G1 even when the printed matter G1 is tampered with by adding a handwritten character, a symbol, or the like or by affixing a seal or the like to the printed matter G1. Even when such tampering is not made, the scan data obtained by scanning the printed matter G1 is basically slightly different from the first scan data obtained by scanning the first analog document G0. In any case, the transaction identification sheet T1 can be used to ensure the authenticity of the first analog document G0 in the printed matter G1.

Although not illustrated, when the printing is executed as described above, the image forming apparatus B (40) may make a registration request for a print transaction indicating that the printing is executed to the server 10, as in the scanning transaction H1 illustrated in FIG. 3. Although not illustrated, the print transaction can include, in addition to the information necessary as the transaction, a transaction list indicating the scanning transaction H1 and the transaction to be referred to, and the transaction type information in the block header. The transaction type information in this example is information indicating printing.

In addition, in the print transaction, the same content as the content exemplified in the scanning transaction H1 is described as the transaction data information. Meanwhile, in the print transaction, the creation of the document in the scanning transaction H1 refers to the printing of the document or is described as the printing of the document.

After the process VII, the printed matter G1 and the transaction identification sheet T1 are set in the image forming apparatus A (20) sequentially or simultaneously (process VIII). In this case, the image forming apparatus A (20) scans the transaction identification sheet T1 to acquire code information such as a QR code, and collates the acquired code information with the code information of the storage destination to recognize that the scanning process is to be continued.

Another image forming apparatus having the same function, such as the image forming apparatus B (40) instead of the image forming apparatus A (20), can also set the transaction identification sheet T1, scan the transaction identification sheet T1, and check the printed code information. Meanwhile, in this case, it is assumed that the code information such as the QR code is stored at a place that can be referred to from the other image forming apparatus. The code information may include information on the storage destination of the code information itself.

The image forming apparatus A (20) that recognizes that the scanning process is to be continued executes the scanning process and the storage process for the printed matter G1 to generate second electronic document data from second scan data, which is scan data of the printed matter G1 in the same manner as the process II. The printed matter G1 is an analog document printed with the image indicated by the first scan data, and hereinafter, the analog document is referred to as a second analog document. The second scan data is data of a scanning result of the second analog document.

The second electronic document data is generated as data in which the authentication information authenticated by the user authentication process in the image forming apparatus A (20) that performs scanning and the hash value of the second scan data are stored in at least one of the header and the footer.

Then, the image forming apparatus A (20) issues a request for registering the second electronic document data in the server 10 as a second transaction referring to the first transaction as the registration process. This process is a process corresponding to the process III, but is different from the process III in that the request is a request for registering as the second transaction that refers to the first transaction.

In this request, when the information for such a reference is included, the server 10 can perform the registration such that the server 10 refers to the first transaction at a time of the registration of the second transaction. As another method, the information for such a reference may be included as information stored in at least one of the header and the footer of the second electronic document data. The server 10 may determine a reference between the transactions based on the information, and register the second transaction.

The second electronic document data is different from the first electronic document data P in that the second electronic document data is registered as the second transaction, but the transmission and printing thereof are the same as those of the first electronic document data P.

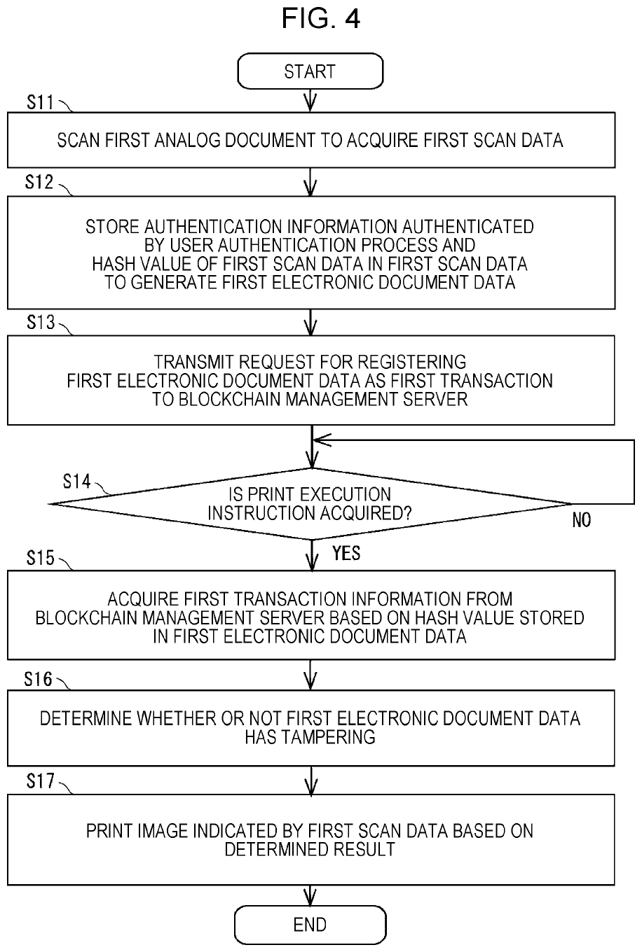

Next, a schematic flow until the execution of printing in the processing example described with reference to FIG. 2 will be described with reference to FIG. 4. FIG. 4 is a flowchart describing a processing example, that is, an example of a printing method executed by the printing system 100.

First, the image forming apparatus A (20) scans the first analog document G0 to acquire first scan data (step S11). Next, the image forming apparatus A (20) stores authentication information authenticated by a user authentication process and a hash value of the first scan data in the first scan data to generate the first electronic document data P (step S12).

Next, the image forming apparatus A (20) transmits a request for registering the first electronic document data P in the server 10 as a first transaction to the server 10 to execute the request (step S13). As a result, the server 10 executes the registration of the first transaction.

Next, the image forming apparatus B (40) determines whether or not a print execution instruction for the first electronic document data P is acquired (step S14). When NO in step S14, the image forming apparatus B (40) waits until YES.

When YES in step S14, the image forming apparatus B (40) acquires first transaction information indicating the first transaction from the server 10 based on the hash value stored in the first electronic document data P (step S15). Then, the image forming apparatus B (40) determines whether or not the first electronic document data P is tampered with based on the first transaction information (step S16). The image forming apparatus B (40) prints an image indicated by the first scan data based on a result determined in step S16 (step S17), and ends the process.

In the above, a processing example when the image forming apparatus A (20) transmits the first electronic document data to the image forming apparatus B (40) is described with reference to FIGS. 2 to 4. On the other hand, when the image forming apparatus A (20) prints the registered first electronic document data P, the process IV is not necessary, and the processes of the process V to the process VII may be executed on the image forming apparatus A (20) side.

In the present embodiment, a printing method including the scanning process, the storage process, the registration process, and the printing process described above, which is executed by the image forming apparatus, can be provided. Alternatively, in the present embodiment, a printing method including the scanning process, the storage process, and the registration process described above, which is executed by the image forming apparatus, can be provided. Alternatively, in the present embodiment, a printing method including the printing process described above, which is executed by the image forming apparatus, can be provided. In the present embodiment, a program for causing a computer provided in an image forming apparatus to execute any printing method can be provided.

### Effects of Present Embodiment

Before describing a more specific example of the process in the present embodiment, effects of the present embodiment will be described.

As described above, in the printing system 100, not only the analog document to be printed can be printed, but also the transaction registration can be performed to detect tampering, so that printing can be electronically managed while ensuring the data authenticity of the analog document. Further, in the printing system 100, the print transaction is also registered, so that a printing history can be included in the management target.

As described above, according to the present embodiment, an analog document in which data authenticity is ensured can be printed while following the existing management method for the analog document, and the analog document and the electronic document can be effectively associated and electronically managed.

In order to supplement the effects, printing systems according to the present embodiment and a comparative example will be compared. Hereinafter, the printing system according to the comparative example will be referred to as a comparative system. In the comparative system, when a document is digitized by PDF or the like from an apparatus provided with a scanning function, the system does not include information such as a feature at a time of generation in the generated electronic document itself. Such information refers to evidence indicating who, when, and with what kind of apparatus generated the document. Therefore, it is unknown what the original document is from which the electronic document generated by the comparative system is made.

In addition, there is a case where the electronic documents are additionally processed, such as a process of adding an electronic signature or an electronic seal by separate software, and are operated to be treated as transaction documents. In the comparative system, when a signed and sealed document, which has already been signed or sealed on the document, is digitized, the document can be intervened by another software in a step of inheriting the electronic document, and there is a risk of tampering and impersonation by unspecified parties, which does not have integrity. Then, in a transaction, it is not trusted without complete evidence that ensures the authenticity as an electronic document handled by the comparative system.

In contrast, the printing system 100 can realize a mechanism that allows exchange of electronic documents, which are easy to transmit and receive such as an e-mail or file transfer, in the workflow of the comparative system that allows analog documents to be transacted as originals. In order to realize this, the printing system 100 employs a method by which transaction security can be ensured, at a stage of generating an electronic document, which is a digital document, from an analog document such as a printed matter or a handwritten document, and at a stage of producing a printed matter, which is an analog document, from the electronic document. In the present embodiment, it can be said that the transaction security can be ensured since tracking management can be performed and the authenticity of the electronic document generated from the original analog document can be ensured.

More specifically, in the printing system 100, in a step of digitizing the original document by the image forming apparatus A (20) using the scanning function, the following information is stored in the transacting electronic document data. That is, authentication information is stored in the electronic document data to be expressed that the electronic document is generated by an authenticated person who is a user who directly operates the image forming apparatus A (20) and is a document creator. Further, the electronic document data stores a hash value of the scan data that is original data for ensuring the authenticity. In the printing system 100, the transaction is registered to manage and cooperate with the electronic document data in which the authentication information and the hash value are stored by using the blockchain.

In the printing system 100, with this mechanism, the electronic document is guaranteed to be converted into a printed matter in a safe manner, that is, in a state in which there is no tampering, impersonation, or the like from the original document, even when the electronic document is distributed to various places thereafter. That is, in the printing system 100, a recipient can receive the document in a form in which the received document is not tampered with or the like without fraud and the authenticity is ensured without any restriction on the method of receiving the electronic document.

In the printing system 100, the recipient of the electronic document can safely convert the electronic document into a printed matter by using an image forming apparatus provided with a mechanism for checking the presence or absence of the fraud. In the printing system 100, the image forming apparatus on the printing side executes printing after collating the transaction information registered in the server 10 with the hash value related to the transaction data stored in the electronic document.

In addition, the recipient can further apply an analog signature, such as a signature or a seal to the printed matter printed in this manner as a document having reliability. In the printing system 100, the document can be digitized again by an image forming apparatus having a scanning function such as the image forming apparatus A (20). As a result, the printing system 100 enables a transaction having high security while maintaining the freedom of portability of the electronic document and keeping the analog document at hand, in a state in which the authenticity of the electronic document is ensured for the next recipient.

As described above, since the authenticity of the printed copy can also be ensured, the printing system 100 can be used as a workflow in a use case when a seal or a signature is applied on an analog document. In other words, the printing system 100 can check for tampering during the step of scanning and printing in the transaction process, and therefore can detect whether such a workflow is running correctly.

Regarding such re-digitizing, the comparative system can provide a mode in which an electronic signature, an electronic seal, or the like is applied to a digitized electronic document by software, and the electronic document is managed in a secure manner and used in a transaction or the like. However, in the comparative system, the analog document to which the signature, the seal, or the like is applied and the electronic document obtained by scanning the original document cannot be safely managed while ensuring the authenticity of the analog document.

Therefore, the printing system 100 is also advantageous in this respect for the comparative system. That is, in the printing system 100, transaction security for maintaining the integrity and the authenticity of the document for use in a reliable transaction can be added while maintaining convenience that the electronic document can be freely moved with the analog document such as the signed and sealed document as an original. In fact, there is no such a scanning apparatus or a printing apparatus that realizes such a mechanism, including the comparative system. Therefore, by providing an image forming apparatus that realizes such a mechanism as in the printing system 100, an evolved mode of safe transactions that integrate analog and digital can be provided.

### First Example of Present Embodiment

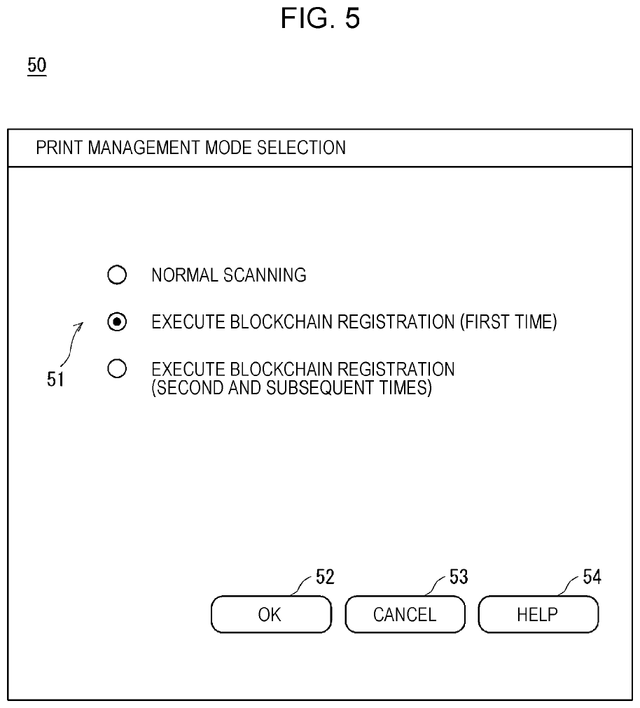

A first example of the present embodiment will be described with reference to FIGS. 5 to 9. In the following description, a processing example when the image forming apparatus A (20) transmits first electronic document data to the image forming apparatus B (40) will be described, but the image forming apparatus A (20) can also print the registered first electronic document data P.

In the first example, an example is given in which the image forming apparatus A (20) on the scanning side can be set to execute or not execute a blockchain registration. First, an example of a UI image for such a setting will be described with reference to FIG. 5. FIG. 5 is a diagram illustrating an example of a UI image displayed by the image forming apparatus A (20) in the printing system 100.

A UI image 50 illustrated in FIG. 5 is an image that can be displayed on the UI section 25, and is displayed by a predetermined user operation. The UI image 50 includes a radio button 51 for setting whether or not to perform the blockchain registration, that is, history management by the blockchain, as an option of a print management mode. The radio button 51 is displayed in a user-selectable manner from among a case of executing normal scanning without performing the blockchain registration, a case of executing a first blockchain registration, and a case of executing second and subsequent blockchain registrations.

Further, the UI image 50 can include an OK button 52, a cancel button 53, and a help button 54. The OK button 52 is a button for storing a set content and closing the UI image 50, for example, for transitioning to the next setting UI image. The cancel button 53 is a button selected when the set content is discarded and the UI image 50 is closed. The help button 54 is a button selected when a UI image or a page of a site on which information assisting the user U is described is displayed when the setting is made on the UI image 50.

The display content in the UI image 50 can be incorporated into and displayed in another UI image, such as a UI image for setting a type of process of the scanned image.

In addition, when the image forming apparatus A (20) is installed in a public institution or the like, the print management mode for performing print management by using the blockchain as described for the UI image 50, that is, authenticity management may be available as a paid option. When normal scanning is performed, it is only necessary to provide a service for a fee for a scanning service, a transmission service accompanied by a scan, a printing service, or the like. Alternatively, the service may be provided free of charge. In this case, for example, the paid mode and the free mode can be switched by changing the setting such as the UI image 50.

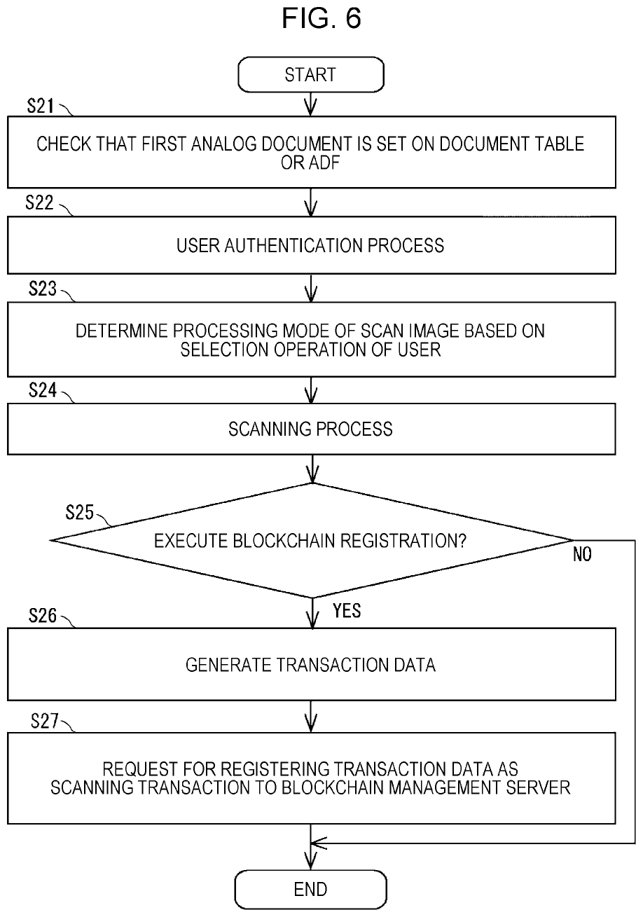

Next, a processing example at a time of first scanning in the first example will be described with reference to FIG. 6. FIG. 6 is a flowchart describing an example of a process at a time of scanning in a printing method executed by the printing system 100. Hereinafter, the same reference numerals as those in FIG. 2 will be used for each document or the like, for example, the first analog document G0 and the like.

First, the image forming apparatus A (20) checks that a user sets the first analog document G0 on a document table or an ADF (step S21). When such a set is not made, the set may be waited for. Hereinafter, a case where the set is made will be described.

Next, the image forming apparatus A (20) causes the authentication processing section 31 to execute a user authentication process (step S22). Hereinafter, a case where the user authentication process is successful will be described. Step S22 may be executed before step S21.

The image forming apparatus A (20) displays a UI image for selecting a scan mode (not illustrated) on the UI section 25 to receive a selection operation by the user, and determines a scan mode according to the selection operation (step S23). The scan mode that is an option can include, for example, a processing mode in which a transmission method of a scanned image is attached to an e-mail, a processing mode in which file transfer is performed, or the like. In addition, it is preferable that a resolution of the scan image, a transmission destination, or the like can also be set from the same UI image.

Next, the scan processing section 27 of the image forming apparatus A (20) gives an instruction to the scanning section 23 to scan the first analog document G0 to acquire first scan data, and the scanning section 23 executes a scanning process (step S24).

Next, the storage processing section 28 determines whether or not a print management mode set in the UI image 50 is a mode in which a blockchain registration is to be executed (step S25). When a setting for executing normal scanning is made by the UI image 50, the first scan data is transmitted to a transmission destination according to the scan mode via the communication section 22 (not illustrated), and the process is ended.

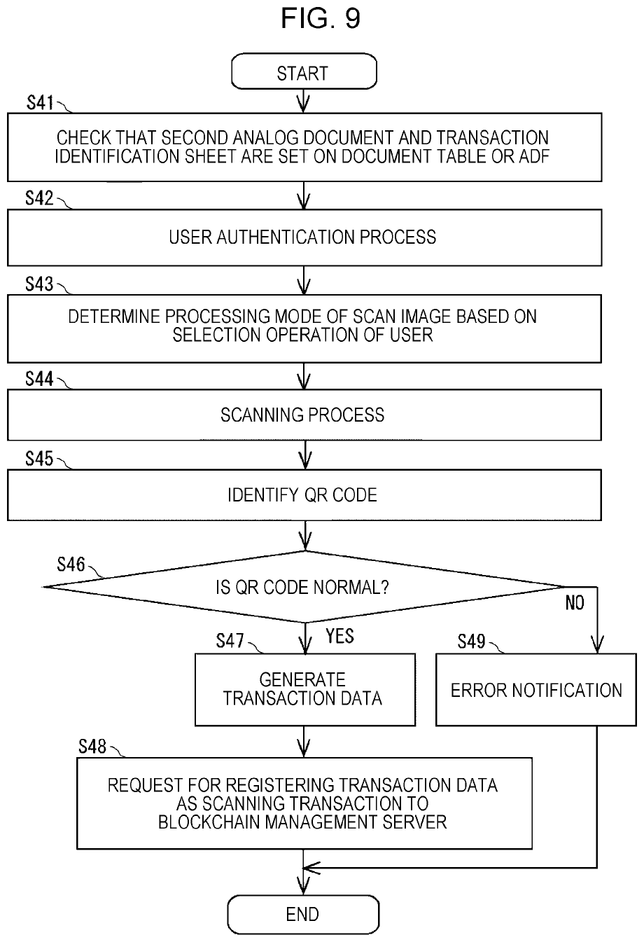

When YES in step S25, the storage processing section 28 stores authentication information authenticated by the user authentication process and a hash value of the first scan data in the first scan data to generate the first electronic document data P as transaction data (step S26). In FIG. 6, a case of setting that a first blockchain registration is executed by the UI image 50 is described, and a case of executing a second blockchain registration will be described later with reference to FIG. 9.

Next, the registration processing section 29 transmits a request for registering the first electronic document data P in the server 10 as the first transaction to the server 10 to execute the request (step S27). The first transaction in this case is a scanning transaction. This request is a request for a transaction indicating that transaction data stored in at least one of a header and a footer of the first electronic document data P is created. As a result, the server 10 executes the registration of the scanning transaction. In this manner, the process of executing the blockchain registration for the first scanning is ended.

The server 10 that manages the blockchain can manage the blockchain with a specific token for each transaction. The server 10 registers, for example, a transaction in which the above transaction data is one block. As a result, the first block is registered in the server 10. Hereinafter, the server 10 executes the transaction registration every time the scan execution from the image forming apparatus A (20) that functions as a scanner apparatus and the print execution from the image forming apparatus B (40) that functions as a printing apparatus are performed, and couples the transaction to the blockchain. In the printing system 100, the management of the printing history with high security is performed in the blockchain in this manner.

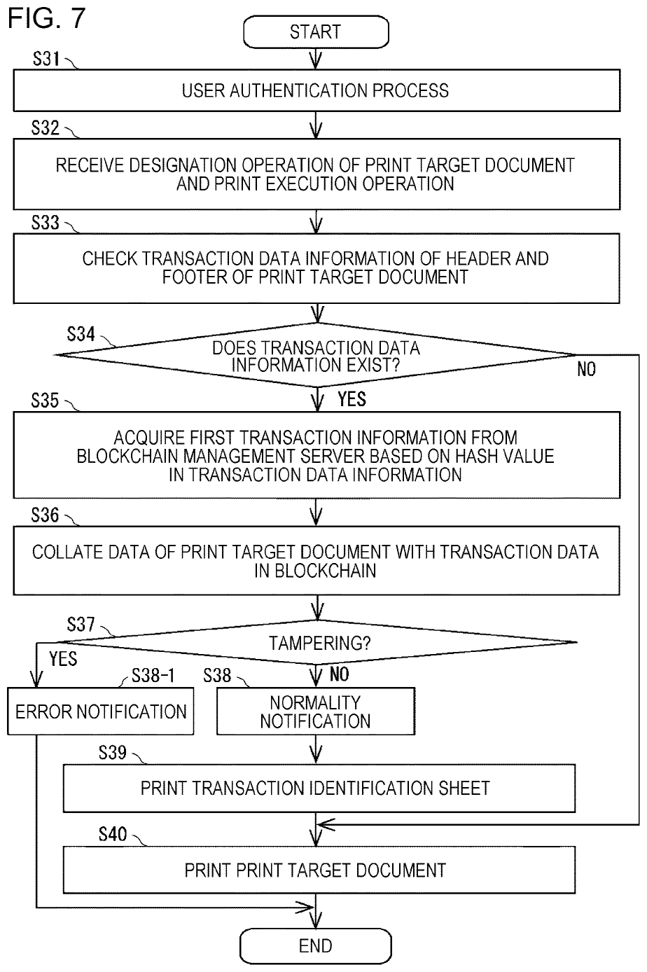

Next, a processing example after the transaction of the scan is registered as described above, including the transaction registration for the print history management, will be described with reference to FIG. 7. This processing example is a processing example at a time of printing in the first example. FIG. 7 is a flowchart describing an example of a process at a time of printing in the printing method executed by the printing system 100.

First, the image forming apparatus B (40) executes a user authentication process in the same authentication processing section as the authentication processing section 31 (step S31). Hereinafter, a case where the user authentication process is successful will be described.

Next, the image forming apparatus B (40) receives a designation operation of the print target document and a print execution operation from the user in the same UI section as the UI section 25 (step S32). Next, the image forming apparatus B (40) checks transaction data information of at least one of the header and the footer of the print target document in a print processing section (hereinafter, print processing section 30B) having the same manner as the print processing section 30 (step S33).

Next, the print processing section 30B determines whether or not the transaction data information exists (step $34). When NO in step S34, the print processing section 30B executes printing of the print target document (step S40) and ends the process.

On the other hand, when YES in step S34, a data of the print target document for which the print execution instruction is received is data corresponding to the first electronic document data P described above. Therefore, in this case, the print processing section 30B acquires first transaction information from the server 10 based on the hash value stored in the data of the print target document (step S35). The print processing section 30B collates the data of the print target document with the transaction data in the blockchain indicated by the first transaction information (step S36).

This collation is for checking whether or not the print electronic document is tampered with in the propagation step, that is, for checking whether or not authenticity is maintained. The transaction data in the blockchain indicated by the first transaction information includes a hash value of the scan data in the transaction data in the blockchain. In this collation, the presence or absence of tampering is determined by comparing the hash value with the hash value in the transaction data stored in at least one of the header and the footer of the data of the print target document.

The print processing section 30B determines whether or not there is tampering as a result of the collation (step S37). When NO in step S37, the print processing section 30B notifies the user that the document is normal, for example, through the same UI section as the UI section 25 or the like (step S38).

The notification when the document is normal may be issued by printing. That is, the notification may be issued by printing on a medium, that is, by producing a printed matter. In that case, the notification content may be included in the transaction identification sheet T1 to be described later. In addition, the notification when the document is normal may include at least one of user information obtained from authentication information of the user who performs scanning, user information obtained from authentication information of the user who performs printing, and transaction data information. The transaction data information is transaction data information regarding transaction data coupled to a blockchain managed by a token, and is information regarding a management history.

Further, the print processing section 30B also executes printing of the transaction identification sheet T1 (step S39). As described above, code information such as a QR code is printed on the transaction identification sheet T1. The code information is information indicating that the blockchain is the same transaction as the existing blockchain, that is, information indicating the same specific token. That is, the code information is information representing a transaction ID that is unique for each transaction of the blockchain.

The reason why the transaction identification sheet T1 is additionally printed is that the transaction identification sheet T1 is used for the transaction continuation. The continuation of the transaction means that the management by the blockchain is continued at the next scan, that is, the management is performed by the same specific token as the previous time. In fact, when the printed matter printed in the step S40 to be described later is scanned again, the scan data is not exactly the same as that at a time of the first scan, and at least a part of the scan data is changed, that is, the scan image is changed. Therefore, for the transaction continuation, whether the transaction is to be continued or new scanning is to be performed may be determined by using such a transaction identification sheet T1.

In the above, the description is made on the premise that the next transaction is always continued. On the other hand, the transaction identification sheet T1 may not always be printed. The print processing section 30B may execute printing of the transaction identification sheet T1 only when the transaction is continued next time.

For example, the image forming apparatus A (20) may be configured to set the presence or absence of such continuation by a user operation. In this case, the image forming apparatus A (20) may transmit information on the presence or absence of continuation to the image forming apparatus B (40) at a time of transmitting the first electronic document data P. As a result, the image forming apparatus B (40) can determine whether or not the transaction is continued, and can determine whether or not to execute printing of the transaction identification sheet T1. Alternatively, on the image forming apparatus B (40) side, the user may be allowed to select whether or not to continue the transaction next time by the user operation in a stage or the like at which the UI section in the same manner as the UI section 25 issues a normality notification in step S38.

After step S39, the print processing section 30B prints an image of a portion corresponding to the first scan data of the print target document (step S40), and ends the process. In addition, at a time of printing in step S38 or after the printing is ended, a registration processing section in the same manner as the registration processing section 29, may generate a print transaction indicating that the printing is executed and request the server 10 to register the transaction, and the server 10 may execute the registration. When NO in step S37, an order of steps S38 to S40 does not matter.

On the other hand, when YES in step S37, the print processing section 30B notifies the user of the error by using the same UI section as the UI section 25 or the like (step S38-1), and ends the process. The notification can include information indicating that there is tampering. This information corresponds to history tampering information. A notification for an error may also be issued by printing. In addition, the notification when there is an error may include at least one of user information of the user who performs scanning, user information of the user who performs printing, and transaction data information, in the same manner as the notification when the document is normal.

As in this example, the error notification can be issued by at least one of a display device provided in the image forming apparatus B (40) and a printed matter printed by the image forming apparatus B (40). In addition, the error notification may be issued in superimposition on the image indicated by the first scan data, or may be issued without including the image.

Further, as in this example, when there is tampering, the print processing section 30B can disable the printing process, such as disabling the printing process other than the notification or disabling the printing process at least when the document is normal. Further, when such disabling is performed, a registration processing section in the same manner as the registration processing section 29 may generate a disable transaction indicating that the registration processing section is disabled and register the transaction in the server 10.

In addition, in this example, a password can be set when scanning the first analog document G0 and the first scan data can be acquired. In step S32, when the designation operation and the print execution operation of the print target document are received from the user, the password authentication may be executed. When the password authentication is successful, in step S33, at least one of the header and the footer of the print target document may be checked for the transaction data information.

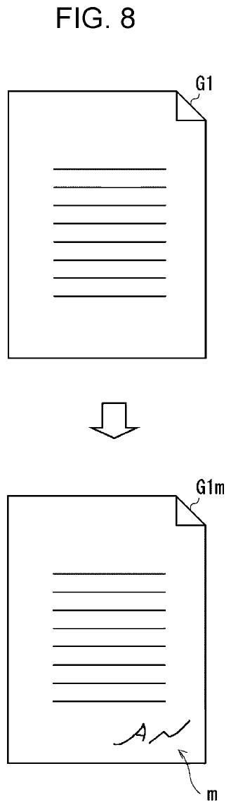

Next, a processing example at a time of second scanning in the first example will be described with reference to FIGS. 8 and 9. FIG. 8 is a diagram illustrating an example of a printed matter printed by the image forming apparatus B (40) in the printing system 100 and a printed matter after handwriting is performed. FIG. 9 is a flowchart describing an example of a process at a time of second scanning in the printing method executed by the printing system 100.

In the following, an example of scanning a printed matter G1m on which a sign m or the like is written with respect to the printed matter G1 as illustrated in FIG. 8 will be described, but the same applies when the printed matter G1 is scanned. In addition, in the following, for the sake of simplifying the description, it is assumed that the print management mode is set to execute the second and subsequent blockchain registrations.

First, the image forming apparatus A (20) checks that the user sets the transaction identification sheet T1 and the printed matter G1m as a second analog document on a document table or an ADF sequentially or simultaneously (step S41). When such a set is not made, the set may be waited for. Hereinafter, a case where the set is made will be described.

As described above, in the image forming apparatus A (20), during scanning, the transaction identification sheet T1 can be interposed at the front when the second analog document such as the printed matter G1m is scanned. As a result, the image forming apparatus A (20) identifies whether or not the transaction is continued depending on the presence or absence of the transaction identification sheet T1, and switches whether or not to store the transaction data of the second electronic document data to be described later and to register the transaction in the server 10. As described above, in the printing system 100, by using the transaction identification sheet T1, the scan method of the transaction continuation or the new transaction can be switched without printing or adding the information on whether or not the transaction is continued to the second analog document itself.

Subsequently, the image forming apparatus A (20) executes the same process as in steps S22 to S24 (steps S42 to S44), and thus, the second scan data is acquired. Meanwhile, in step S44, the scan data obtained by scanning the transaction identification sheet T1 is also acquired.

The checking in step S41 may be a check of whether or not a plurality of scan target analog documents are set. In fact, it is sufficient that it is checked that the first analog document and the transaction identification sheet T1 are set by the scanning process in step S44.

Next, the scan processing section 27 of the image forming apparatus A (20) identifies a QR code from the data obtained by scanning the transaction identification sheet T1 (step S45). Here, the scan processing section 27 scans the transaction identification sheet T1 to acquire code information such as the QR code, and collates the acquired code information with the code information of the storage destination. Next, the scan processing section 27 obtains the collation result and determines whether or not the scanning process is to be continued depending on whether or not the QR code is a normal code (step S46).

When YES in step S46, that is, when it can be recognized that the scanning process is the scanning process of the transaction continuation, the scan processing section 27 executes the next process. That is, the scan processing section 27 acquires the second scan data, which is scan data of the printed matter G1m, for the registration of the second transaction referring to the existing first transaction as the result of the scanning process on the printed matter G1 in step S44.

Meanwhile, the scan processing section 27 may, for example, first scan the transaction identification sheet T1, and execute the scanning process for the printed matter G1m only when the QR code is normal. As a result, the second scan data for the second transaction registration, which is the scan data of the printed matter G1m, can be acquired.

As described above, when scanning a second analog document obtained by printing the image indicated by the first scan data and a transaction identification sheet obtained by printing code information indicating a transaction ID of the first transaction, the scan processing section 27 performs the following process. That is, in this case, the scan processing section 27 acquires the second scan data for registration of the second transaction.

Next, the storage processing section 28 stores the authentication information authenticated by the user authentication process and the hash value of the second scan data in the second scan data to generate second electronic document data as the transaction data (step S47).

After the process in step S47, the registration processing section 29 transmits a request for registering the generated transaction data in the server 10 as a second transaction for referring to the first transaction to the server 10 to execute the request (step S48). In this request, when the information for such a reference is included, the server 10 can perform the registration such that the server 10 refers to the first transaction at a time of the registration of the second transaction.

The second transaction in this case is a second scanning transaction. Therefore, referring to the first transaction means referring to the print transaction when the print transaction is registered, and further indirectly referring to the scanning transaction for the first scanning.

The server 10 that receives such a request executes the registration of the second scanning transaction. In this manner, the process of executing the blockchain registration for the second scanning is ended. In addition, since the hash value of the scan data is generated for each scanning, the tampering detection based on the comparison between the scan data, that is, the comparison between the images is enabled until the next scanning transaction.

On the other hand, when NO is determined in step S46, that is, when it cannot be recognized that the scanning process is continued, the scan processing section 27 is currently set to execute the second and subsequent blockchain registrations, and thus issues an error notification (step S49) and ends the process.

Here, the transaction identification sheet T1 will be additionally described. The transaction identification sheet T1 may be stored in at least one of the image forming apparatus A (20) and the image forming apparatus B (40) or the server 10 or a separately provided server to be printed at any time.

As a result, when it is desired to perform the next scan, the transaction identification sheet T1 can be printed. Further, by storing the transaction identification sheet T1 in a printable manner at any time, for example, the transaction identification sheet T1 can be used as one for enabling an option for managing the authenticity, such as a paid option or the like described above. For example, the printing system 100 may be configured as a system that permits printing of the transaction identification sheet T1 only when the option is selected.

### Second Example of Present Embodiment

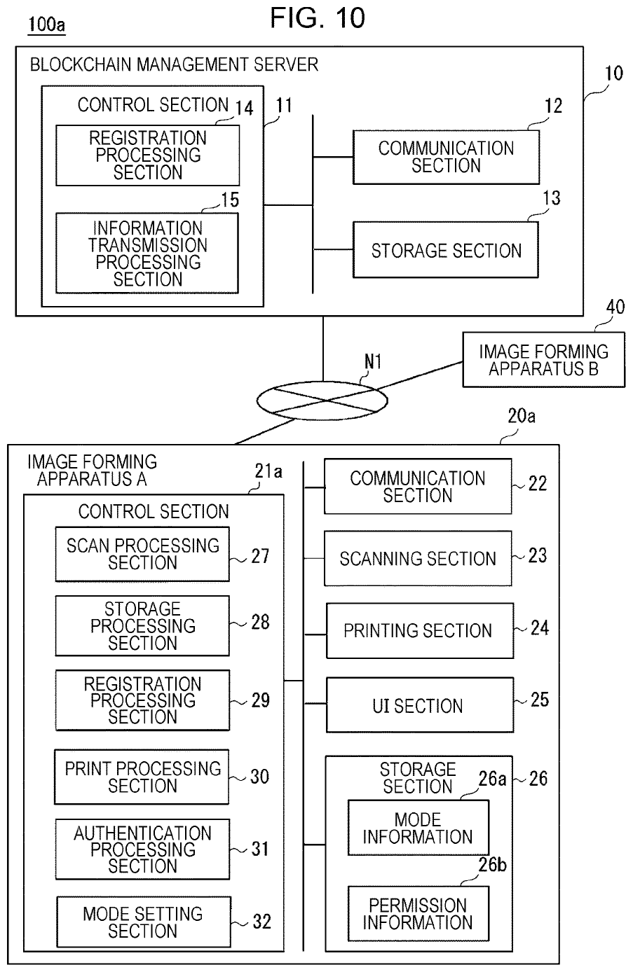

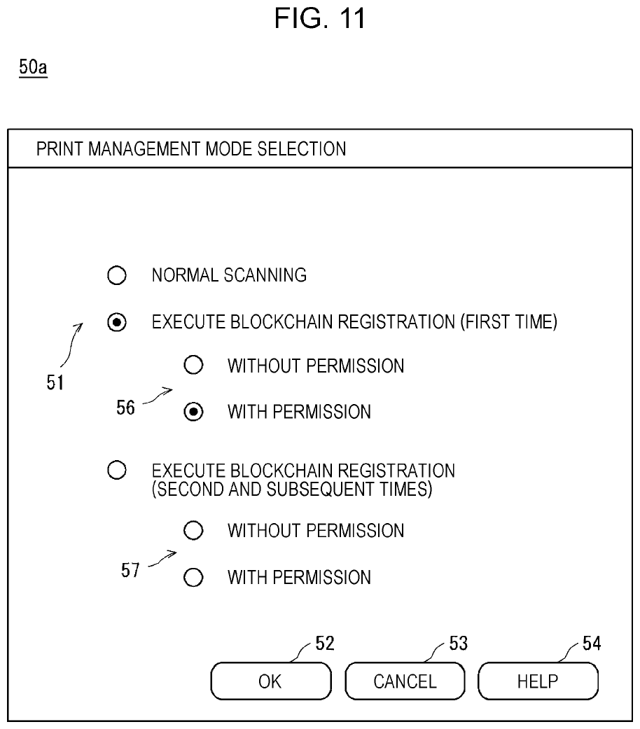

A second example of the present embodiment will be described with reference to FIGS. 10 to 13. First, a configuration example of a printing system according to the second example will be described with reference to FIGS. 10 and 11. FIG. 10 is a block diagram illustrating another configuration example of the printing system including the image forming apparatus according to the embodiment. FIG. 11 is a diagram illustrating an example of a UI image displayed by an image forming apparatus A (20a) in a printing system 100a in FIG. 10. Hereinafter, the second example will be described mainly focusing on a difference from the first example, but other points are the same, including the application of various application examples.

As illustrated in FIG. 10, the printing system 100a, which is the second example of the printing system 100, includes the image forming apparatus A (20a) instead of the image forming apparatus A (20). The image forming apparatus B (40) may also have the same configuration as the image forming apparatus A (20a).

The image forming apparatus A (20a) has a control section 21a including a mode setting section 32 as the control section 21 in the image forming apparatus A (20), and stores mode information 26a and authority information 26b in the storage section 26.

The mode setting section 32 sets a print management mode by a user operation on the UI section 25, and stores the set mode as the mode information 26a in the storage section 26 such that the mode information 26a can be referred to at a time of printing including a time of a storage process and a time of a registration process. The mode information 26a is information indicating the print management mode, and in an example in which the print management mode can be set in the first example, the mode information 26a is merely information that can be omitted in the description. Therefore, even in the example in which the print management mode can be set in the first example, the mode setting section 32 is provided in the control section 21.

In the second example, it is assumed that such a print management mode is enabled or that the image forming apparatus is configured to always perform a process corresponding to the print management mode in an image forming apparatus in which such a mode setting cannot be performed.

The storage processing section 28 in the second example determines whether or not to execute a process based on authority for managing authenticity, which is set according to a user authenticated by a user authentication process. The registration processing section 29 also determines whether or not to execute the process according to the determination.

This authority can be set by an operation of the user on the UI section 25 as a first setting method. For example, a UI image such as a UI image 50a illustrated in FIG. 11 may be displayed on the UI section 25 to receive the operation from the user. A display content in the UI image 50a can be incorporated into and displayed in another UI image, such as a UI image for setting a type of process of a scanned image. In addition, the example described with reference to the UI image 50 can be applied to an application example when the image forming apparatus A (20) is installed in a public institution or the like.

The UI image 50a includes each of a radio button 56 and a radio button 57 for selecting whether or not to give authority, for a first blockchain registration and second and subsequent blockchain registrations, in the UI image 50 in FIG. 5.

For example, in a selection example illustrated in FIG. 11, the selection is performed such that the first blockchain registration is to be performed, and authority for the next and subsequent blockchain registrations is to be set for the user. In this case, the second and subsequent blockchain registrations for the first electronic document data P registered in the first blockchain registration are permitted only for the user and are not permitted for other users. The first blockchain registration is permitted since the user sets the first blockchain registration.

In the same manner, in the UI image 50a, the second and subsequent blockchain registrations can be performed and the authority for the next and subsequent blockchain registrations can be set for the user. Meanwhile, the radio button 57 may display a UI image not to allow a change from giving authority to not giving authority, for the user who does not have authority at the previous scanning.

The control section 21a stores the authority information 26b associated with a user who is an authority setting target, in the storage section 26. The authority information 26b is stored to be referable at a time of the storage process or to be referable at a time of the storage process and the time of the registration process.

Alternatively, the setting of the authority to manage the authenticity may be simply set for each user as a second setting method. In this case, the authority can be set by an operation of an administrator user from the UI section 25 or the like. When the user authenticated by the user authentication process is a user who does not have the authority, the process of the blockchain registration is not permitted, and only the user who has the authority can execute the process of the blockchain registration.

In addition, in either case of the first and second setting methods, when the storage processing section 28 only determines whether or not to execute the storage process with reference to the authority information 26b, the setting is enabled only in the set image forming apparatus A (20a).

On the other hand, the storage processing section 28 can also apply the presence or absence of the authority to an image forming apparatus other than the image forming apparatus A (20) at a time of the first scan by registering the setting for the electronic document data with the authority to manage the authenticity in the transaction.

For that purpose, the storage processing section 28 may store the authority information in the first electronic document data P based on the authority to manage the authenticity set according to the user authenticated by the user authentication process. More specifically, the storage processing section 28 may store user information indicating the user having authority, for the electronic document data to which the authority is given, in at least one of the header and the footer.

As described above, the storage processing section 28 can be configured to store authority information indicating the authority in the first electronic document data P based on the authority for managing the authenticity set according to the user authenticated by the user authentication process. As a result, the authority to manage the authenticity of the first electronic document data P can be given to the user. Since the first electronic document data P already exists at this stage, the authority refers to the authority when the second and subsequent transactions are continued.

For the first electronic document data P subjected to such a storage process, such authority information is also included as the transaction data at a time of the transaction registration. Therefore, the storage processing section 28 can disable the process of the user who has no authority at a time of the next and subsequent scanning. When the storage process is disabled, the registration process in the subsequent registration processing section 29 is also disabled.

In addition, the authority given in the second setting method may be given at the same time to, for example, a user authenticated by the user authentication process, another user having the same level or a higher level of access authority to a confidential document, or still another user belonging to the same group.

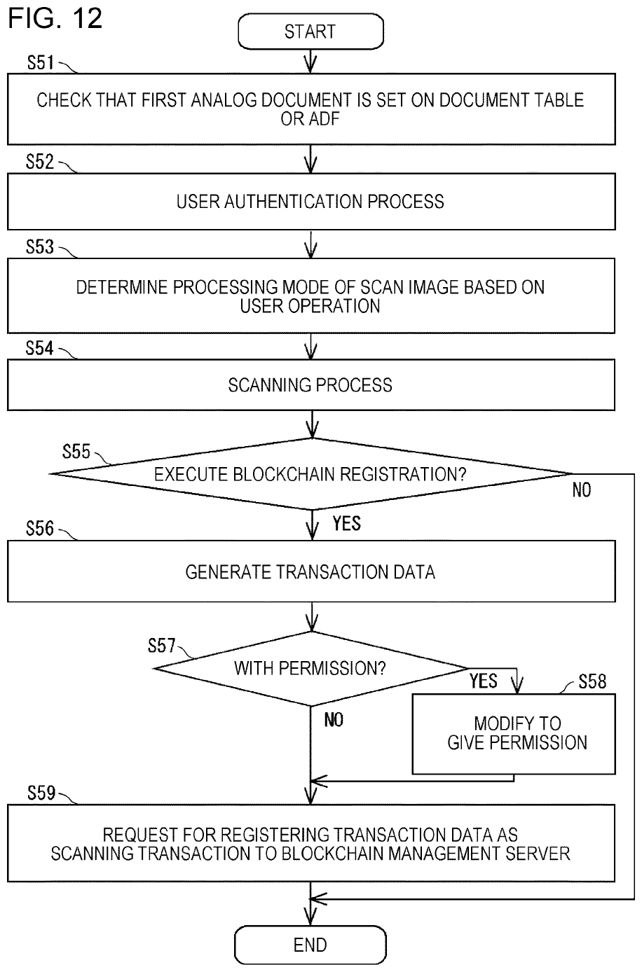

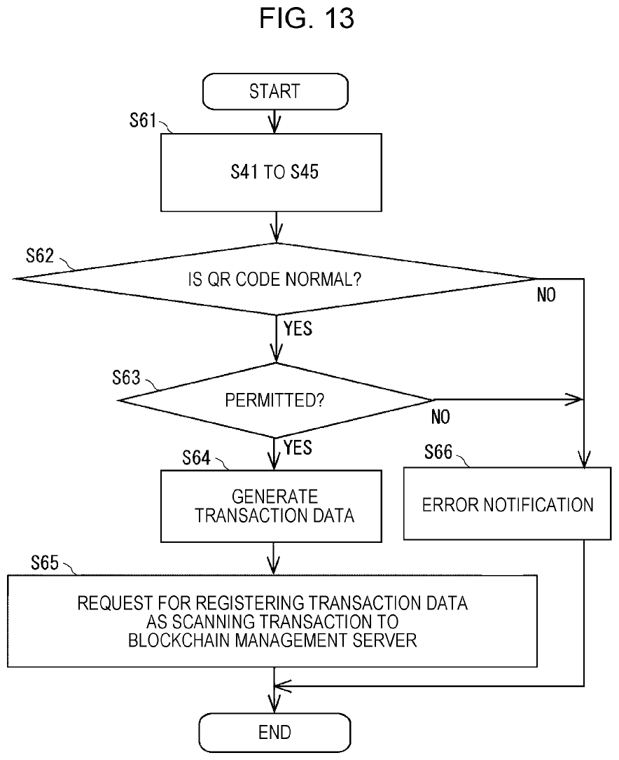

Next, a process in the second example will be described with reference to FIGS. 12 and 13. FIG. 12 is a flowchart describing an example of a process at a time of scanning in a printing method executed by the printing system 100a. FIG. 13 is a flowchart describing an example of a process at a time of printing in the printing method executed by the printing system 100a.

As illustrated in FIG. 12, even during scanning in the second example, the same process as the process of steps S21 to S26 in FIG. 6 in the first example is executed (steps S51 to S56). When NO in step S55, the process is ended. Hereinafter, an example in which authority information is stored in the first electronic document data P will be described.

After step S56, the storage processing section 28 refers to the authority information 26b with information of the user authenticated by the user authentication process as a key, and determines whether or not to give authority to the first electronic document data P (step S57). When NO in step S57, the registration processing section 29 executes the same process as in step S27 in FIG. 6 (step S59), and ends the process.

On the other hand, when YES in step S57, the first electronic document data P in which the authentication information and the hash value are already stored in step S56, the storage processing section 28 modifies the first electronic document data P (step S58). The modification is a modification for storing user information indicating the user having authority in at least one of the header and the footer of the first electronic document data P as the transaction data generated in step S56.

Next, the registration processing section 29 transmits a request for registering the modified first electronic document data P in the server 10 as a first transaction to the server 10 to execute the request (step S59), and ends the process. The first transaction in this case is a scanning transaction having an authority. This request is a request for a transaction indicating that the transaction data having the authority stored in at least one of the header and the footer of the first electronic document data P is created.

The server 10 that receives the request executes the registration of the scanning transaction having the authority for the next and subsequent scanning. In this manner, the process of executing the blockchain registration for the first scanning is ended. As a result, since such authority information is also included as the transaction data at a time of the transaction registration, a process of the user who has no authority at a time of the storage process can be disabled at a time of the next and subsequent scanning to be described later with reference to FIG. 13.

In FIG. 12, for convenience, a processing example from a state in which the user has no authority is described for each user. However, the authority information may be modified as necessary such that the authority information according to the determination in step S57 is stored in the first electronic document data P. For example, the process in step S56 may be executed according to the determination result in step S57.

In addition, although an example in which the authority information is stored in the first electronic document data P is described, when such storage is not performed, the authority is already set for each user. Therefore, when such storing is not performed, it is sufficient to notify of an error even when YES is determined in step S55 when a user has no authority.

Next, the next and subsequent scanning will be described. First, as illustrated in FIG. 13, the image forming apparatus A (20) executes the processes of steps S41 to S45 in FIG. 9 (step S61). Next, the scan processing section 27 determines whether or not the scanning process is continued depending on whether or not the QR code is a normal code, in the same manner as in step S46 (step S62).

When YES in step S62, that is, when it can be recognized that the scanning process is a scanning process of the transaction continuation, the scan processing section 27 acquires the second scan data for registration of the second transaction referring to the existing first transaction, in the same manner as the processes after step S45.

Next, the storage processing section 28 determines whether or not the authority is given to the user authenticated by the user authentication process in the first transaction (step S63). The storage processing section 28 may access the server 10 in the same manner as the print processing section 30B to acquire first transaction information indicating the first transaction, and execute the determination in step S63 based on the authority information included in the first transaction information.

When YES in step S63, the storage processing section 28 generates the second electronic document data as transaction data, including the authentication information, the hash value of the second scan data, and the acquired authority information (step S64). For example, when the authority information is to be changed at the next and subsequent scanning, the authority information included in the transaction data may be modified.

After the process in step S64, in the same manner as in step S48, the registration processing section 29 issues a request for registering the generated transaction data as a second transaction for referring to the first transaction in the server 10, to the server 10 (step S65), and ends the process.

On the other hand, when NO in step S63, the storage processing section 28 issues an error notification (step S66), and ends the process. In this case, it means that the storage processing section 28 disables the storage process. Further, when NO in step S62, the scan processing section 27 issues an error notification (step S66), and ends the process.

In addition, the scan processing section 27 in the first example and the second example may include the following process. That is, the scan processing section 27 may issue a notification for prompting the scanning of the transaction identification sheet when the transaction identification sheet T1 is not scanned when the print management mode is enabled. This notification can be issued by displaying a UI image on the UI section 25. The UI image may be an image including a button or the like for causing the user to perform a designation operation that the UI image is the first scanning. As a result, the user can cause the image forming apparatus A (20) to execute the first scan without causing the transaction identification sheet to be scanned when the transaction is registered as the first scanning.

### Other Modification Examples

The present disclosure is not limited to the embodiments described above, and can be appropriately changed without departing from the gist. For example, the system configuration of the printing system, the configuration of each apparatus constituting the printing system, the configuration of each program included in each apparatus, the processing procedure of each apparatus, and the like are not limited to the examples.

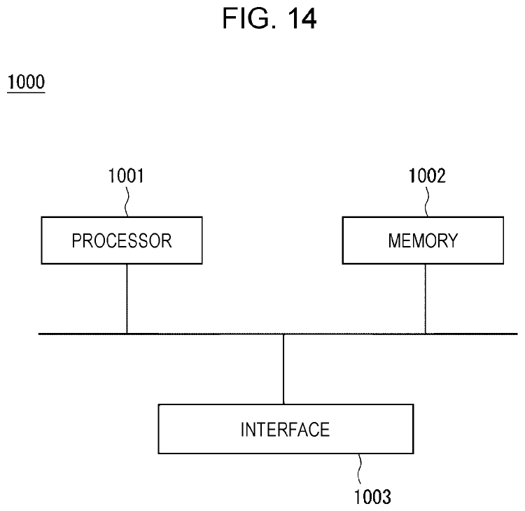

In addition, each of the apparatuses included in the printing system according to the embodiment described above can include, for example, the following hardware configuration. Here, with reference to FIG. 1, each apparatus includes, for example, a blockchain management server and each image forming apparatus, and also includes a terminal device that can be coupled to the image forming apparatus. FIG. 14 is a diagram illustrating an example of a hardware configuration of the apparatus.

An apparatus 1000 illustrated in FIG. 14 can include a processor 1001, a memory 1002, and an interface 1003. The interface 1003 can include an interface with, for example, a communication interface, an input and output device, or the like, which is required according to the apparatus.

The processor 1001 may be, for example, a CPU, a GPU, or a microprocessor also referred to as a microprocessor unit (MPU) or the like. The processor 1001 may include a plurality of processors. The memory 1002 is configured with, for example, a combination of a volatile memory and a non-volatile memory. A function of each device is realized by the processor 1001 reading a program stored in the memory 1002 and executing the program while exchanging necessary information via the interface 1003.

In addition, the program described above includes a group of commands (or software code) for causing a computer to perform one or more functions described in the embodiment when the program is read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or another memory technology. By way of non-limiting example, the computer-readable medium or the physical storage medium includes a CD-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. By way of non-limiting example, the transitory computer-readable medium or communication medium includes a propagating signal in an electrical, optical, acoustic, or another form.

The present disclosure is described above with reference to the embodiments. However, the present disclosure is not limited to the configurations of the embodiments, and it is needless to say that various modifications, amendments, and combinations that can be made by those skilled in the art are included within the scope of the present disclosure.

What is claimed is:

1. A printing method executed by an image forming apparatus, the method comprising:
executing a scanning process of scanning a first analog document, which is a portable document printed on a medium, to acquire first scan data;
executing a storage process of storing authentication information authenticated by a user authentication process and a hash value of the first scan data in the first scan data to generate first electronic document data;
executing a registration process of issuing a request for registering the first electronic document data as a first transaction to a blockchain management server; and
executing a printing process of, when a print execution instruction for the first electronic document data is acquired,
acquiring first transaction information indicating the first transaction from the blockchain management server, based on the hash value stored in the first electronic document data,
determining whether or not the first electronic document data is tampered with based on the first transaction information, and
printing an image indicated by the first scan data, based on a result of the determination.

2. The printing method according to claim 1, wherein
in the printing process, code information indicating a transaction ID of the first transaction is printed as a transaction identification sheet to identify that next scanning is scanning to be continuously managed by the blockchain management server.

3. The printing method according to claim 1, wherein
in the scanning process, when a second analog document obtained by printing the image indicated by the first scan data and a transaction identification sheet obtained by printing code information indicating a transaction ID of the first transaction are scanned, second scan data which is a scanning result of the second analog document is acquired for registering a second transaction referring to the first transaction,
in the storage process, the authentication information authenticated by the user authentication process and a hash value of the second scan data are stored in the second scan data to generate second electronic document data, and
in the registration process, a request for registering the second electronic document data as the second transaction referring to the first transaction is issued to the blockchain management server.

4. The printing method according to claim 1, wherein
in the printing process, when the first electronic document data is determined not to be tampered with, the image indicated by the first scan data is printed, and when the first electronic document data is determined to be tampered with, an error notification is issued.

5. The printing method according to claim 4, wherein
the error notification is issued by at least one of a display device provided in the image forming apparatus and a printed matter printed by the image forming apparatus.

6. The printing method according to claim 1, wherein
the storage process and the registration process are executed when a management mode for executing management of authenticity is enabled.

7. The printing method according to claim 6, wherein
in the scanning process, when the management mode is enabled and a transaction identification sheet obtained by printing code information indicating a transaction ID of the first transaction is not scanned, a notification for prompting the transaction identification sheet to be scanned is issued.

8. The printing method according to claim 1, wherein
in the storage process, whether or not to execute the process is determined based on authority for managing authenticity, the authority being set according to a user authenticated by the user authentication process.

9. The printing method according to claim 1, wherein
in the storage process, authority information is stored in the first electronic document data, based on authority for managing authenticity, the authority being set according to a user authenticated by the user authentication process.

10. An image forming apparatus comprising:
a scan processing section that scans a first analog document, which is a portable document printed on a medium, to acquire first scan data;
a storage processing section that stores authentication information authenticated by a user authentication process and a hash value of the first scan data in the first scan data to generate first electronic document data;
a registration processing section that issues a request for registering the first electronic document data as a first transaction to a blockchain management server; and
a print processing section, wherein
the print processing section is configured to, when a print execution instruction for the first electronic document data is acquired,
acquire first transaction information indicating the first transaction from the blockchain management server, based on the hash value stored in the first electronic document data,
determine whether or not the first electronic document data is tampered with based on the first transaction information, and
print an image indicated by the first scan data, based on a result of the determination.

11. An image forming system comprising:
an image forming apparatus; and
a blockchain management server coupled to the image forming apparatus, wherein
the image forming apparatus includes
a scan processing section that scans a first analog document, which is a portable document printed on a medium, to acquire first scan data,
a storage processing section that stores authentication information authenticated by a user authentication process and a hash value of the first scan data in the first scan data to generate first electronic document data,
a registration processing section that issues a request for registering the first electronic document data as a first transaction to the blockchain management server, and
a print processing section,
the print processing section is configured to, when a print execution instruction for the first electronic document data is acquired,
acquire first transaction information indicating the first transaction from the blockchain management server, based on the hash value stored in the first electronic document data,
determine whether or not the first electronic document data is tampered with based on the first transaction information, and
print an image indicated by the first scan data, based on a result of the determination, and
the blockchain management server includes
a server-side registration processing section that registers the first electronic document data as data of the first transaction in response to the request, and
an information transmission section that returns the first transaction information to the image forming apparatus in response to a request for acquiring the first transaction information from the image forming apparatus.
